(19) United States
(12) Patent Application Publication
(10) Pub. No.: US 2007/0214204 A1
(43) Pub. Date: Sep. 13, 2007

(54) Negative two's complement numbering system

(76) Inventor: Earl Swartzlander JR., Austin, TX (US)

Correspondence Address: Brian P. Klawinski, 5338A Darling Street, Houston, TX, 77007, US

(21) Appl. No.: 11/370,783

(22) Filed: Mar. 8, 2006

(51) Int. Cl. G06F 7/38

(52) U.S. Cl. 708/490

(57) ABSTRACT

The present invention provides a solution to the shortcomings of the traditional two's complement system that is commonly utilized in modern computing systems and digital signal processors.

The previously described shortcoming of the two's complement system are corrected in the present invention is a number system described as the negative two's complement system. In the negative two's complement system a n-bit number, A, has a sign bit, aₙ₋₁, and n−1 fractional bits, aₙ₋₂, aₙ₋₃, . . . , a₀. The value of an n-bit fractional negative two's complement number is:

$$A = {a}_{n - 1} + {\sum }_{i = 0}^{n - 2} - {a}_{i} {2}^{i - n + 1} .$$

### BACKGROUND OF THE INVENTION

Of the three predominant fixed point number systems, two's complement, one's complement, and sign/magnitude, the two's complement system is the most widely used. The explanation for this is that the most commonly preformed arithmetic functions, such as addition and subtraction, are relatively easy to implement and fast for two's complement numbers.

One aspect of the current fractional two's complement number system is that the most negative number that can be represented is −1 while the most positive number that can be represented is one unit in the least significant position (ULP) less than +1. This results in a problem wherein not all multiplication products can be represented. For example, −1×−1 produces a result (+1) that cannot be represented as a fractional two's complement number. Therefore a need exists for a new system wherein all multiplication products produce a result that can be represented.

### BRIEF SUMMARY OF THE INVENTION

The present invention is an improved method for arithmetic functionality in computer systems and digital signal processors, more particularly; the present invention includes a new numbering system for use in computer systems and digital signal processors, yet still more particularly; the claimed invention includes a new numbering system for use in computers and digital signal processors wherein the product of all possible multiplications can be represented in the numbering system.

### BRIEF DESCRIPTION OF THE FIGURES

FIG. 1 illustrates a modern computer system wherein the current invention is implemented.

FIG. 2 depicts a more detailed computer system wherein the claimed invention is utilized.

FIG. 3 depicts a digital signal processor wherein the claimed invention is utilized.

### DETAILED DESCRIPTION OF THE INVENTION

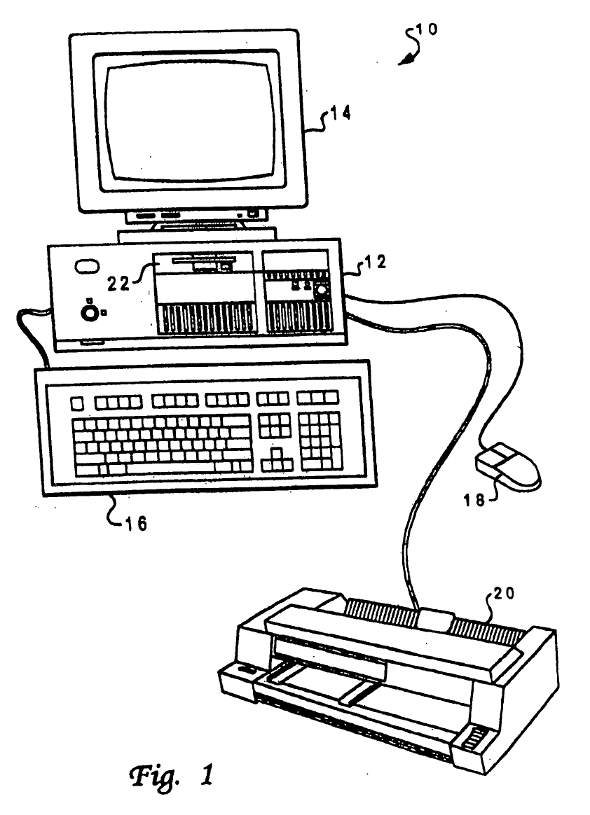

FIG. 1 illustrates a pictorial representation of a data processing system 10 in accordance with the present invention. Computer system 10 includes a computer 12, a monitor 14, a keyboard 16, a mouse 18, a plotter 20, a printer 21, and a floppy drive 22. Computer system 10 may be implemented utilizing any commercially available computer system which has been suitably programmed and which has been modified as described below. Computer system 10 is capable of receiving a variety of different types of inputs from a variety of different types of input devices. Keyboard 16 and mouse 18 are two such types of input devices.

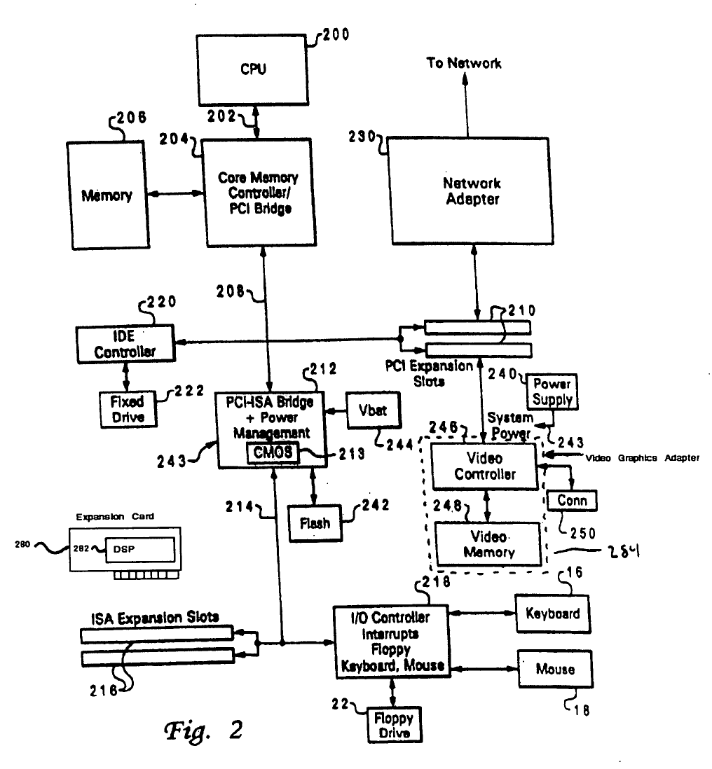

FIG. 2 depicts a more detailed pictorial representation of the computer system of FIG. 1 in accordance with the present invention. Computer system 12 includes a printed circuit board (also commonly called a motherboard or system board) which is mounted within computer 12 and provides a means for mounting and electrically interconnecting various components of computer 12 including a central processing unit (CPU) 200, system memory 206, and accessory cards or boards as is well known in the art.

CPU 200 is connected by address, control, and data buses 202 to a memory controller and peripheral component interconnect (PCI) bus bridge 204 which is coupled to system memory 206. An integrated drive electronics (IDE) device controller 220, and a PCI bus to Industry Standard Architecture (ISA) bus bridge 212 are connected to PCI bus bridge 204 utilizing PCI bus 208. IDE controller 220 provides for the attachment of IDE compatible storage devices, such as a removable hard disk drive 222. PCI/ISA bridge 212 provides an interface between PCI bus 208 and an optional feature or expansion bus such as the ISA bus 214. PCI/ISA bridge 212 includes power management logic. PCI/ISA bridge 212 is supplied power from battery 244 to prevent loss of configuration data stored in CMOS 213.

A PCI standard expansion bus with connector slots 210 is coupled to PCI bridge 204. PCI connector slots 210 may receive PCI bus compatible peripheral cards. An ISA standard expansion bus with connector slots 216 is connected to PCI/ISA bridge 212. ISA connector slots 216 may receive ISA compatible adapter cards such as expansion card 280. It will be appreciated that other expansion bus types may be used to permit expansion of the system with added devices. It should also be appreciated that two expansion buses are not required to implement the present invention.

An I/O controller 218 is coupled to PCI-ISA bridge controller 212. I/O controller 218 controls communication between PCI-ISA bridge controller 212 and devices and peripherals such as keyboard 16, mouse 18, and floppy drive 22 so that these devices may communicate with CPU 200.

PCI-ISA bridge controller 212 includes an interface for a flash memory 242 which includes an interface for address, data, flash chip select, and read/write. Flash memory 242 is an electrically erasable programmable read only memory (EEPROM) module and includes BIOS that is used to interface between the I/O devices and operating system.

Computer 12 includes a video controller 246 which may, for example, be plugged into one of PCI expansion slots 210. Video controller 246 is connected to video memory 248. The image in video memory 248 is read by controller 246 and displayed on monitor 14 which is connected to computer 12 through connector 250. A video graphics adapter 284 is comprised of video controller 246 and video memory 248. Video graphics adapter 284 computes sine and cosine for video operations.

Computer 12 includes a power supply 240 which supplies full normal system power 243. Computer 12 also includes a network adapter 230. Network adapter 230 may be plugged into one of the PCI connector slots 210 (as illustrated) or one of the ISA connector slots 216 in order to permit computer 12 to communicate with a network.

Computer 12 includes an expansion card 280. Expansion card 280 may be any number of devices that extend the functionality of computer 12, including without limitation wireless network adapters, audio cards, video adapters, special purpose adapters, data capture and acquisition adapters. Those skilled in the art will readily acknowledge that expansion card 280 could be connected to computer 12 via different types of expansion slots such as USB, EISA, PCI slots 210, and PCI-E.

Expansion card 280 includes a digital signal processor (DSP) 282. Digital signal processor 282 calculates arithmetic operations utilizing the present invention, representing numbers in a negative two's complement system.

In the preferred embodiment the present invention is implemented in hardware, such as in CPU 200. In another embodiment, the present invention can be implemented in a digital signal processor (DSP), such as DSP 282. In yet another embodiment, the present invention can be implemented in computer program code.

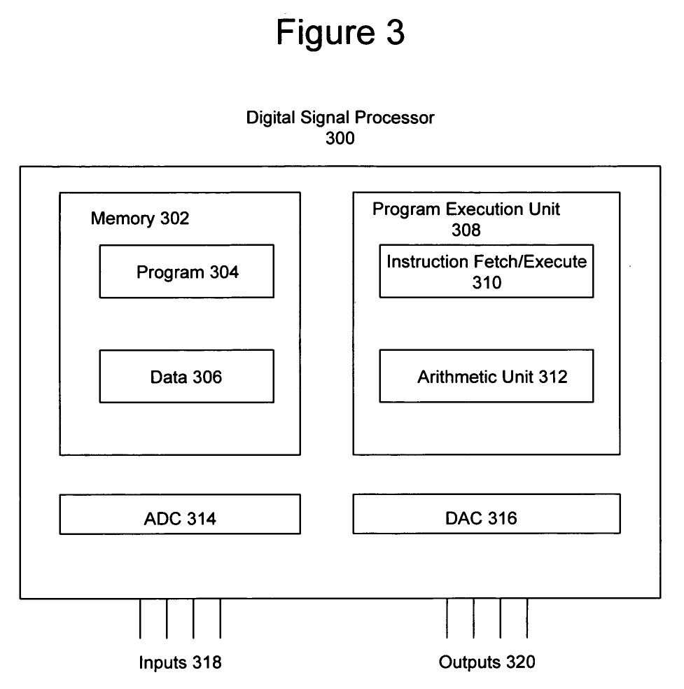

FIG. 3 illustrates a high level block diagram of a digital signal processor wherein the present invention is utilized. Digital Signal Processor (DSP) 300 contains memory unit 302. In the preferred embodiment, memory unit 302 follows the Harvard architecture wherein program and data memory are stored separately. In FIG. 3, program memory 304 represents the portion of memory dedicated to program instructions and data memory 306 depicts the area of memory allocated for data. Those skilled in the art will readily appreciate that the present invention is useful in a DSP regardless of the memory architecture.

Digital signal processor 300 also contains a program execution unit 308. Program execution unit 308 contains subunits for performing specific operations of DSP 300. One such sub unit is instruction fetch/execute unit 310. This unit is responsible for retrieving instructions from program memory 304 and executing them.

As depicted in FIG. 3, DSP 300 contains arithmetic unit 312 wherein the present invention is implemented. Arithmetic unit 312 is responsible for performing numeric computations, and in accordance with the present invention, represents numbers in a negative two's complement system. Additionally, in the preferred embodiment of the claimed invention, arithmetic unit 312 includes an extra bit for detecting overflow during numeric operations and for properly complementing the number one (1).

Analog to digital converter 314 converts analog inputs 318 to a binary representation for use in DSP 300. Similarly, analog converter 316 converts binary data from DSP 300 to analog for use on outputs 320. Inputs 318 and Outputs 320 include both analog and digital pins.

FIGS. 1-3 illustrate the computer system and digital signal processors wherein the negative two's compliment system is utilized. The details of the negative two's compliment number system as implemented in the claimed invention is described in detail below.

An n-bit fractional negative two's complement number, A, has a sign bit, an 1, and n−1 fractional bits, aₙ₋₂, aₙ₋₃, . . . a₀. The value of an n-bit fractional negative two's complement number is:

$$A = {a}_{n - 1} + {\sum }_{i = 0}^{n - 2} - {a}_{i} {2}^{i - n + 1} .$$

This is identical to the formula for conventional fractional two's complement numbers except that the signs of all weights (negative for the sign bit and positive for all other bits for conventional numbers) are reversed.

Table 1 shows the values of 4-bit fractional negative two's complement numbers and 4-bit fractional two's complement numbers.

TABLE 1
4-bit Fractional Negative Two's Complement
and Conventional Two's Complement Numbers

| | Negative Two's | |
|---|---|---|
| Value | Complement Number | Two's Complement Number |
| 1 | 1 0 0 0 | N/A |
| ⅞ | 1 0 0 1 | 0 1 1 1 |
| ¾ | 1 0 1 0 | 0 1 1 0 |
| ⅝ | 1 0 1 1 | 0 1 0 1 |
| ½ | 1 1 0 0 | 0 1 0 0 |
| ⅜ | 1 1 0 1 | 0 0 1 1 |
| ¼ | 1 1 1 0 | 0 0 1 0 |
| ⅛ | 1 1 1 1 | 0 0 0 1 |
| 0 | 0 0 0 0 | 0 0 0 0 |
| −⅛ | 0 0 0 1 | 1 1 1 1 |
| −¼ | 0 0 1 0 | 1 1 1 0 |
| −⅜ | 0 0 1 1 | 1 1 0 1 |
| −½ | 0 1 0 0 | 1 1 0 0 |
| −⅝ | 0 1 0 1 | 1 0 1 1 |
| −¾ | 0 1 1 0 | 1 0 1 0 |
| −⅞ | 0 1 1 1 | 1 0 0 1 |
| −1 | N/A | 1 0 0 0 |

Given the definition of the two systems, it is not surprising that the arithmetic operations of addition, subtraction and complementation are the same for fractional negative two's complement and two's complement numbers. Examples for four bit fractional negative two's complement numbers serve to illustrate the process.

The standard arithmetic operations are performed as is described below. Those skilled in the art will readily appreciate the similarity of the standard arithmetic operations under the traditional two's complement system with the present invention.

The implementation of addition is identical to that of conventional two's complement arithmetic. For example, for operands A (=aₙ₋₁. aₙ₋₂, . . . , a₀) and B (=bₙ₋₁. bₙ₋₂, . . . , b₀) with a carry input c₀, the sum S (=sₙ₋₁. sₙ₋₂, . . . , s₀) is given by:
cᵢ₊₁=aᵢbᵢ+aᵢcᵢ+bᵢcᵢ for i=0, 1, . . . , n−1 and sᵢ₌ₐᵢ⊕bᵢ⊕cᵢ for i=0, 1, . . . , n−1

where ⊕ denotes exclusive OR, + denotes OR and • denotes AND.

As with the conventional two's complement number system, subtraction is performed by adding the complement of the number. As for the conventional two's complement system, the complement is formed by inverting all bits of the number and adding a 1 at the least significant bit position.

$$\begin{matrix}\frac{1}{2} + \frac{3}{8} & & 1. 1 \; 0 \; 0 & & & - \frac{1}{4} + \frac{3}{8} & & 0. 0 \; 1 \; 0 & \\ & & \underline{1. 1 \; 0 \; 1} & & & & & \underline{1. 1 \; 0 \; 1} & \\ & & 1. 0 \; 0 \; 1 & = \frac{7}{ 8} & & & & 1. 1 \; 1 \; 1 & = \frac{1}{ 8}\end{matrix}$$

$$\begin{matrix}\frac{1}{2} - \frac{7}{8} & & 1. 1 \; 0 \; 0 & & & - \frac{1}{4} - \frac{1}{2} & & 0. 0 \; 1 \; 0 & \\ & & \underline{0. 1 \; 1 \; 1} & & & & & \underline{0. 1 \; 0 \; 0} & \\ & & 0. 0 \; 1 \; 1 & = - \frac{3}{ 8} & & & & 0. 1 \; 1 \; 0 & = - \frac{3}{ 4}\end{matrix}$$

As for the conventional two's complement number system, overflow may be detected by comparing the carry into the sign bit and the carry out from the sign bit. If the carries differ, overflow has occurred. In the first case (below left) Cᵢₙ=0 and Cₒᵤₜ=1, in the second case Cᵢₙ=1 and Cₒᵤₜ=0.

$$\begin{matrix}\frac{1}{2} + \frac{7}{8} & & 1. 1 \; 0 \; 0 & & & - \frac{1}{2} - \frac{3}{4} & & 0. 1 \; 0 \; 0 & \\ & & \underline{1. 0 \; 0 \; 1} & & & & & \underline{0. 1 \; 1 \; 0} & \\ & & 0. 1 \; 0 \; 1 & = - \frac{5}{8} & & & & 1. 0 \; 1 \; 0 & = \frac{3}{ 4}\end{matrix}$$

Overflow can occur only when adding numbers of like signs. It also may be detected by checking if the sign of the sum differs from the signs of the operands.

Overflow can be accommodated by allowing the word size of the result to increase by 1 bit. In this case there are two integer bits (a sign bit with a weight of 2 and a unit bit with a weight of −1), and n−1 negatively weighted fractional bits.

$$\begin{matrix}\frac{1}{2} + \frac{7}{8} & & 1. 1 \; 0 \; 0 & \\ & & \underline{1. 0 \; 0 \; 1} & \\ & & 10. 1 \; 0 \; 1 & = 1 \frac{3}{8}\end{matrix}$$

$$\begin{matrix}- \frac{1}{2} - \frac{3}{4} & & 0. 1 \; 0 \; 0 & \\ & & \underline{0. 1 \; 1 \; 0} & \\ & & 01. 0 \; 1 \; 0 & = - 1 \frac{1}{4}\end{matrix}$$

To change the sign of fractional negative two's complement numbers, all the bits of the number are inverted and a one is added at the least significant bit position.

$$\begin{matrix}\frac{1}{2} & & 1. 1 \; 0 \; 0 & \\ & invert all bits & 0. 0 \; 1 \; 1 & \\ & add 1 LSB & \underline{0. 0 \; 0 \; 1} & \\ & & 0. 1 \; 0 \; 0 & = - \frac{1}{2}\end{matrix}$$

$$\begin{matrix}- \frac{1}{2} & & 0. 1 \; 0 \; 0 & \\ & invert all bits & 1. 0 \; 1 \; 1 & \\ & add 1 LSB & \underline{0. 0 \; 0 \; 1} & \\ & & 1. 1 \; 0 \; 0 & = \frac{1}{2}\end{matrix}$$

Complementation of +1 produces an erroneous result since there is no representation of −1 in the number system.

$$\begin{matrix}1 & & 1. 0 \; 0 \; 0 & \\ & invert all bits & 0. 1 \; 1 \; 1 & \\ & add 1 LSB & \underline{0. 0 \; 0 \; 1} & \\ & & 1. 0 \; 0 \; 0 & = 1\end{matrix}$$

As with additive overflow, if the result is increased in size by one bit (a sign bit with a weight of 2, a unit bit with a weight of −1, and n−1 negatively weighted fractional bits) the complementation of +1 produces a result of 0 1 . 0 0 0 (i.e., −1) which is correct. Therefore, any possible errors in complementing a number in the present invention are avoidable by using an extra bit in the result.

Booth/modified Booth multipliers are widely used for two's complement numbers. With suitable modification, they are suitable for negative two's complement numbers. Both Booth and modified Booth multipliers are implemented with sequences of addition, subtraction and shift operations. Since equivalent operations are available for negative two's complement numbers, the resulting multipliers will be similar to conventional two's complement Booth multipliers. The only difference for negative two's complement multipliers is that the addition and subtraction conditions are reversed from those of conventional two's complement multipliers. For the Booth multiplier, two bits of the multiplier number (augmented with an extra 0 at the least significant end) are inspected on each cycle. The extra 0 is shown in italics in the following examples. Table 2 gives the operations that produce the partial product, P. After the partial product is computed, the multiplier bits are shifted by one bit position (i.e., multiplied by two) and the partial product is shifted down by one bit position (i.e., divided by two). On the last cycle, no shift is performed.

TABLE 2
Booth Multiplier Operations for Negative
Two's Complement Numbers

| MULTIPLIER BITS | OPERATION |
|---|---|
| 0 0 | P = P |
| 0 1 | P = P − B |
| 1 0 | P = P + B |
| 1 1 | P = P |

For example:

$$\begin{matrix}\frac{3}{4} \cdot \frac{5}{8} & & 1. 0 \; 1 \; 0 & \\ & & \underline{1. 0 \; 1 \; 1 \; 0} & \\ & & & \\ 10 \text{:} Add B & & \underline{1. 0 \; 1 \; 0} & \\ & & 1. 0 \; 1 \; 0 & \\ Shift P & & 1. 1 \; 0 \; 1 \; 0 & \\ 11 \text{:} No \text{-} Op & & 1. 1 \; 0 \; 1 \; 0 & \\ Shift P & & 1. 1 \; 1 \; 0 \; 1 \; 0 & \\ 01 \text{:} Subtract B & & \underline{0. 1 \; 1 \; 0} & \\ & & 0. 1 \; 0 \; 0 \; 1 \; 0 & \\ Shift P & & 0. 0 \; 1 \; 0 \; 0 \; 1 \; 0 & \\ 10 \text{:} Add B & & \underline{1. 0 \; 1 \; 0} & \\ No Shift & & 1. 1 \; 0 \; 0 \; 0 \; 1 \; 0 & = \frac{15}{32}\end{matrix}$$

$$\begin{matrix}- \frac{3}{4} \cdot \frac{5}{8} & & 0. 1 \; 1 \; 0 & \\ & & \underline{1. 0 \; 1 \; 1 \; 0} & \\ & & & \\ 10 \text{:} Add B & & \underline{0. 1 \; 1 \; 0} & \\ & & 0. 1 \; 1 \; 0 & \\ Shift P & & 0. 0 \; 1 \; 1 \; 0 & \\ 11 \text{:} No \text{-} Op & & 0. 0 \; 1 \; 1 \; 0 & \\ Shift P & & 0. 0 \; 0 \; 1 \; 1 \; 0 & \\ 01 \text{:} Subtract B & & \underline{1. 0 \; 1 \; 0} & \\ & & 1. 0 \; 1 \; 1 \; 1 \; 0 & \\ Shift P & & 1. 1 \; 0 \; 1 \; 1 \; 1 \; 0 & \\ 10 \text{:} Add B & & \underline{0. 1 \; 1 \; 0} & \\ No Shift & & 0. 0 \; 1 \; 1 \; 1 \; 1 \; 0 & = - \frac{15}{32}\end{matrix}$$

$$\begin{matrix}\frac{3}{4} \cdot - \frac{5}{8} & & 1. 0 \; 1 \; 0 & \\ & & \underline{0. 1 \; 0 \; 1 \; 0} & \\ & & & \\ 10 \text{:} Add B & & \underline{1. 0 \; 1 \; 0} & \\ & & 1. 0 \; 1 \; 0 & \\ Shift P & & 1. 1 \; 0 \; 1 \; 0 & \\ 01 \text{:} Subtract B & & \underline{0. 1 \; 1 \; 0} & \\ & & 0. 0 \; 1 \; 1 \; 0 & \\ Shift P & & 0. 0 \; 0 \; 1 \; 1 \; 0 & \\ 10 \text{:} Add B & & \underline{1. 0 \; 1 \; 0} & \\ & & 1. 0 \; 1 \; 1 \; 1 \; 0 & \\ Shift P & & 1. 1 \; 0 \; 1 \; 1 \; 1 \; 0 & \\ 01 \text{:} Subtract B & & \underline{ 0. 1 \; 1 \; 0} & \\ No Shift & & 0. 0 \; 1 \; 1 \; 1 \; 1 \; 0 & = - \frac{15}{32}\end{matrix}$$

$$\begin{matrix}- \frac{3}{4} \cdot - \frac{5}{8} & & 0. 1 \; 1 \; 0 & \\ & & \underline{0. 1 \; 0 \; 1 \; 0} & \\ & & & \\ 10 \text{:} Add B & & \underline{0. 1 \; 1 \; 0} & \\ & & 0. 1 \; 1 \; 0 & \\ Shift P & & 0. 0 \; 1 \; 1 \; 0 & \\ 01 \text{:} Subtract B & & \underline{1. 0 \; 1 \; 0} & \\ & & 1. 1 \; 0 \; 1 \; 0 & \\ Shift P & & 1. 1 \; 1 \; 0 \; 1 \; 0 & \\ 10 \text{:} Add B & & \underline{0. 1 \; 1 \; 0} & \\ & & 0. 1 \; 0 \; 0 \; 1 \; 0 & \\ Shift P & & 0. 0 \; 1 \; 0 \; 0 \; 1 \; 0 & \\ 01 \text{:} Subtract B & & \underline{1. 0 \; 1 \; 0} & \\ No Shift & & 1. 1 \; 0 \; 0 \; 0 \; 1 \; 0 & = \frac{15}{32}\end{matrix}$$

Modified Booth multipliers are implemented much like Booth multipliers. For radix-4 modified Booth multipliers, three bits of the multiplier number (augmented with an extra 0 at the least significant end) are inspected on each cycle. The extra 0 is shown in italics in the following examples. Table 3 gives the operations that produce the partial product, P. After the partial product is computed, the multiplier bits are shifted by two bit positions and the partial product is shifted down by two bit positions (i.e., divided by four). On the last cycle, no shift of the partial product is performed.

TABLE 3
Radix-4 Modified Booth Multiplier Operations
for Negative Two's Complement Numbers

| MULTIPLIER BITS | OPERATION |
|---|---|
| 0 0 0 | P = P |
| 0 0 1 | P = P − B |
| 0 1 0 | P = P − B |
| 0 1 1 | P = P − 2 B |
| 1 0 0 | P = P + 2 B |
| 1 0 1 | P = P + B |
| 1 1 0 | P = P + B |
| 1 1 1 | P = P |

For example:

$$\begin{matrix}\frac{3}{4} \cdot \frac{5}{8} & & 1. 0 \; 1 \; 0 & \\ & & \underline{1. 0 \; 1 \; 1 \; 0} & \\ & & & \\ 110 \text{:} Add B & & \underline{1. 0 \; 1 \; 0} & \\ & & 1. 0 \; 1 \; 0 & \\ Shift P & & 1. 1 \; 1 \; 0 \; 1 \; 0 & \\ 101 \text{:} Add B & & \underline{1. 0 \; 1 \; 0} & \\ No Shift & & 1. 1 \; 0 \; 0 \; 0 \; 1 \; 0 & = \frac{15}{32}\end{matrix}$$

Those skilled in the art will readily appreciate that the present invention that has been described here for fractional numbers applies equally to integers. An n-bit integer negative two's complement number, A, has a sign bit, aₙ₋₁, and n−1 integer bits, aₙ₋₂, aₙ₋₃, . . . , a₀. Bit a₀ has a weight of −1, bit a₁ has a weight of −2, . . . , bit aₙ₋₂ has a weight of −2ⁿ⁻², and the sign bit aₙ₋₁ has a weight of +2ⁿ⁻¹, The value of an n-bit fractional negative two's complement integer is:

$$A = {a}_{n - 1} {2}^{n - 1} + {\sum }_{i = 0}^{n - 2} - {a}_{i} {2}^{i}$$

This is identical to the formula for conventional two's complement integer numbers except that the signs of all weights (negative for the sign bit and positive for all other bits for conventional numbers) are reversed.

Those skilled in the art will appreciate that the described invention may be implemented in computer systems, computer program code, or digital signal processors with variations from those described above without departing from the spirit of the claimed invention.

1. A digital signal processor comprising an arithmetic unit that represents numbers in fractional negative two's complement form, where a n-bit number, A, has a sign bit, aₙ₋₁, and n−1 fractional bits, aₙ₋₂, aₙ₋₃, . . . , a₀ with a value of
$$A = {a}_{n - 1} + {\sum }_{i = 0}^{n - 2} - {a}_{i} {2}^{i - n + 1} .$$

2. The digital signal processor as described in claim 1, where the arithmetic unit comprises an extra bit for arithmetic operation results to detect overflow.

3. The digital signal processor as described in claim 1, where the arithmetic unit comprises an extra bit for arithmetic operation results to properly handle complementing 1.

4. A computer system comprising an arithmetic unit that represents numbers in fractional negative two's complement form, where a n-bit number, A, has a sign bit, aₙ₋₁, and n−1 fractional bits, aₙ₋₂, aₙ₋₃, . . . , a₀ with a value of
$$A = {a}_{n - 1} + {\sum }_{i = 0}^{n - 2} - {a}_{i} {2}^{i - n + 1} .$$

5. The computer system as described in claim 4, where the arithmetic unit comprises an extra bit for arithmetic operation results to detect overflow.

6. The computer system as described in claim 4, where the arithmetic unit comprises an extra bit for arithmetic operation results to properly handle complementing 1.

7. A computer program comprising instructions that simulate arithmetic computations wherein numbers are represented in fractional negative two's complement form, where a n-bit number, A, has a sign bit, aₙ₋₁, and n−1 fractional bits, aₙ₋₂, aₙ₋₃, . . . , a₀ with a value of
$$A = {a}_{n - 1} + {\sum }_{i = 0}^{n - 2} - {a}_{i} {2}^{i - n + 1} .$$

8. The computer program as described in claim 7, where said computer program includes instructions that simulate an extra bit for arithmetic operation results to detect overflow.

9. The computer program as described in claim 7, where said computer program includes instructions that simulate an extra bit to properly handle complementing 1.

10. A digital signal processor comprising an arithmetic unit that represents numbers in integer negative two's complement form, where a n-bit number, A, has a sign bit, aₙ₋₁, and n−1 fractional bits, aₙ₋₂, aₙ₋₃, . . . , a₀ with a value of
$$A = {a}_{n - 1} {2}^{n - 1} + {\sum }_{i = 0}^{n - 2} - {a}_{i} {2}^{i} .$$

11. The digital signal processor as described in claim 10, where the arithmetic unit comprises an extra bit for arithmetic operation results to detect overflow.

12. The digital signal processor as described in claim 10, where the arithmetic unit comprises an extra bit for arithmetic operation results to properly handle complementing the largest positive number.

13. A computer system comprising an arithmetic unit that represents numbers in integer negative two's complement form, where a n-bit number, A, has a sign bit, aₙ₋₁, and n−1 fractional bits, aₙ₋₂, aₙ₋₃, . . . , a₀ with a value of
$$A = {a}_{n - 1} {2}^{n - 1} + {\sum }_{i = 0}^{n - 2} - {a}_{i} {2}^{i} .$$

14. The computer system as described in claim 13, where the arithmetic unit comprises an extra bit for arithmetic operation results to detect overflow.

15. The computer system as described in claim 13, where the arithmetic unit comprises an extra bit for arithmetic operation results to properly handle complementing the largest positive number, 2ⁿ⁻¹.

16. A computer program comprising instructions that simulate arithmetic computations wherein numbers are represented in integer negative two's complement form, where a n-bit number, A, has a sign bit, aₙ₋₁, and n−1 fractional bits, aₙ₋₂, aₙ₋₃, . . . a₀ with a value of
$$A = {a}_{n - 1} {2}^{n - 1} + {\sum }_{i = 0}^{n - 2} - {a}_{i} {2}^{i} .$$

17. The computer program as described in claim 16, where said computer program includes instructions that simulate an extra bit for arithmetic operation results to detect overflow.

18. The computer program as described in claim 16, where said computer program includes instructions that simulate an extra bit to properly handle complementing the largest positive number, 2^{n-1.}
